(19) United States
(12) Patent Application Publication
(10) Pub. No.: US 2005/0112290 A1
(43) Pub. Date: May 26, 2005

(54) Method for the production of polyolefinic optical films

(76) Inventors: Andreas Hartbrich, Weil am Rhein (DE); Manfred Hildebrand, Basel (CH); Wolfgang Keller, Kembs-Loechle (FR); Gerhard Markt, Basel (CH); Ulrich Siemann, Weil am Rhein (DE); Wolfgang Werner, Bad Krozingen (DE)

Correspondence Address: Fisher Christen & Sabol, Suite 1108, 1725 K Street NW, Washington, DC, 20006, US

(21) Appl. No.: 10/506,293

(22) PCT Filed: Mar. 5, 2004
(86) PCT No.: PCT/EP03/02240

(30) Foreign Application Priority Data
Mar. 5, 2002 (EP) 02004932.6

(51) Int. Cl. B05D 1/02

(52) U.S. Cl. 427/447

(57) ABSTRACT

A process for producing an optical film from a polyolefin of the formula: 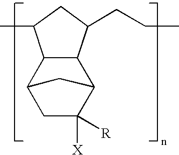 in which R and X are either both hydrogen, or R is methyl and X is a polar group, and n is a number from 10 to 1000.

The invention relates to a process for the production of polyolefin films by casting a polymer solution onto a substrate. In particular, it relates to a process for producing optical films from polyolefins of the formula 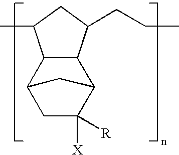
in which at every occurrence of the substituents R and X they are either both hydrogen or R is methyl and X is a polar group, and n is a number from 10 to 1000, by casting solutions of the polyolefins in organic solvents onto a substrate and evaporating the solvents.

Polyolefins of the above formula are known for their good optical properties and are commercially available by way of example with the name ARTON® (X=methoxycarbonyl, producer: Japan Synthetic Rubber Co.). A requirement for various applications is to use this material to produce optical films which have not only constant thickness but also a smooth and defect-free surface, and are free from streaking, and in particular have minimum and constant optical retardation. The only method of obtaining this combination of properties, if indeed it can be obtained, is to use a casting process in which a solution of the polymer is cast onto a substrate and solidified via evaporation of the solvent, and finally in the form of a film is peeled away from the substrate. However, it has been found that use of the usual conditions for producing other optical films (e.g. from cellulose triacetate) by the casting process does not give films which meet all of the requirements.

It was therefore an object of the present invention to provide a production process for optical films from the above-mentioned polyolefins which in particular gives films with extremely low optical retardation.

The invention achieves this object via the process as claimed in claim 1.

It has been found that films with very low optical retardation can be produced from polyolefins of the formula 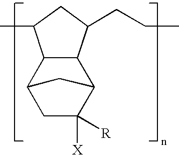
in which at every occurrence of R and X they are either both hydrogen or R is methyl and X is a polar group, and n is a number from 10 to 1000, by casting a solution of the polyolefin in an organic solvent onto a substrate and evaporating the solvent, if
(i) the polyolefin is dissolved in an organic solvent or solvent mixture, and
(ii) the solution obtained in this way is cast onto a smooth substrate in an atmosphere comprising at least 1% by volume of solvent vapor at a temperature below the boiling point of the solvent, with substantially laminar gas flow being maintained over the casting substrate,
(iii) the solvent is evaporated to obtain a self-supporting film, and
(iv) the film is peeled away from the substrate and dried at a temperature rising to 70-140° C., without any resultant orientation of the film.

The above formula encompasses homo- and copolymers, depending on whether at each occurrence R and X are identical or different.

In principle, suitable solvents are any of the organic solvents of low polarity in which the polyolefin used has sufficient solubility and which have a boiling point below the glass transition temperature of the polyolefin. Among these, by way of example, are halogenated hydrocarbons, such as dichloromethane or dichloroethane, aromatic hydrocarbons, such as toluene or xylene, aliphatic and cycloaliphatic hydrocarbons, such as cyclohexane, and also mixtures of the solvents mentioned. The solvents and solvent mixtures whose use is preferred have been selected from the groups consisting of dichloromethane, toluene, cyclohexane, and their mixtures. Particular preference is given to dichloromethane and solvent mixtures comprising dichloromethane. Those used may be mixtures of dichloromethane with other volatile solvents, such as methanol, the dichloromethane advantageously being the main constituent.

The casting solutions advantageously also comprise additives, such as heat stabilizers, to inhibit thermal degradation, for example during the drying process, and/or release agents, to facilitate the peeling-away of the casting substrate. Examples of suitable release agents are detergents, plasticizers, such as phosphoric, phthalic or adipic esters, metal soaps, fatty acid amides, or polyethylene glycols, and derivatives of these, such as ethers or esters.

The casting substrate used preferably comprises a continuous belt, for example composed of polished stainless steel or of a polymer film.

In another preferred embodiment, the casting substrate used comprises a polymer film, for example composed of Teflon or polyester. In this case, the two sub-steps “peeling away from the substrate” and drying in step (iv) of the process may, where appropriate, also be carried out in reverse sequence, by drying and winding-up the casting substrate and the cast film together, and not separating the substrate from the film until a subsequent step of the process has been reached.

The substantially laminar gas flow is advantageously achieved by introducing solvent-containing gas (preferably air) in the vicinity of the casting gap in such a way that the gas proceeds in the same direction as the casting substrate and the velocity of the gas relative to that of the substrate is very small or zero. In continuous operation, the solvent-containing gas is advantageously drawn off at the end of the drying zone and recycled by way of a condenser. The solvent content can thus easily be adjusted via change of the condenser temperature, as determined by the vapor pressure curve, and the condensed solvent can be reclaimed.

The casting procedure is preferably carried out with a casting solution temperature which is below the solvent boiling point by at least 2 K, particularly preferably 10-20 K. If the casting temperature is too close to the boiling point of the solvent, there is a risk that uncontrolled evaporation will form inhomogeneous regions.

The inventive process is preferably used to produce films from polyolefins of the above formula in which at least some of the substituents X are C₁₋₄-alkoxycarbonyl groups.

Particular preference is given to polyolefins in which at least some of the substituents X are methoxycarbonyl groups.

Very particular preference is given to polyolefins in which some of the substituents R and X are hydrogen and the remainder are methyl and methoxycarbonyl. These copolymers may either be block copolymers or else be random or alternating copolymers.

The concentration of the polyolefin in the casting solution is preferably from 10 to 40% by weight, particularly preferably from 20 to 35% by weight.

The thickness of the films which can be produced according to the invention is preferably from 30 to 200 μm. The inventive process can produce films with an optical retardation of less than 10 nm at 100 μm thickness and a variation in optical retardation in the longitudinal and transverse direction of only about +1 nm (at 100 μm thickness). Very low variation in optical retardation is therefore ensured in a subsequent stretching process to produce optically functional films (compensation and retardation films for LCD, λ/2 films, and λ/4 films, etc.).

In order to achieve a particularly low residual content of solvent (<<1%), the film can, where appropriate, be subjected to a second drying process under substantially identical temperature conditions, but advantageously with a lower web speed of the film.

The examples below illustrate the conduct of the inventive process but should not be regarded as a restriction.

### EXAMPLE 1

Production of a Cast Film from ARTON® G with a Thickness of 100 μm

A homogeneous solution was prepared from 5000 kg of ARTON® G (homopolymer, R=methyl, X=methoxycarbonyl) and 13182 kg of dichloromethane, with stirring and slight heating, and was filtered in a filter press through a filter composed of a layer of calmuc fabric, a metal sieve with mesh width 12 μm, and a layer of cotton batiste. The filtered solution was heated to 40° C. for degassing and then temperature-controlled to 33° C. and cast in an atmosphere with about 3% by volume content of dichloromethane vapor and having a temperature of 34° C., at the required thickness (casting gap about 500 μm) onto a polished circulating steel belt of length 60 m and width about 1.27 m, circulating at 3.6 m/min. The air comprising dichloromethane was introduced into the region of the casting gap in such a way as to give a linear gas velocity of about 2-5 m/s in the direction of the belt (corresponding to a relative velocity of about ±1.5 m/s). The temperature in the belt duct was raised toward the take-off point in stages to about 60° C., and the film formed was peeled away. This was then dried over a length of about 260 m at a temperature rising in stages from about 60° C. in the region of the first 120 m of length to about 115° C. in the final third, and finally, after cooling, was cut to a width of 1010 mm, and wound up.

Once stationary-state operating conditions had been established, the film obtained had a residual solvent content of about 1.45% by weight and an optical retardation of about 10 nm.

### EXAMPLE 2

Production of a Cast Film from ARTON® G with a Thickness of 100 μm

Using a method based on Example 1, a solution was prepared from 3840 kg of ARTON® G and 8939 kg of dichloromethane, and cast, using a belt velocity of 4.9 m/min. The resultant film with residual solvent content (determined to ASTM 1003) of 1.34% by weight, an optical retardation (measured at 632 nm) of 9 nm, and haze of 0.27% was first wound up and then after-dried in a continuous dryer at a temperature of 125—132° C. over a length of 121 m at a velocity of 2 m/min. After this after-drying, the residual solvent content was 0.08% by weight, and the optical retardation was 9.5 nm. The haze had risen very slightly to 0.45%.

### EXAMPLE 3

Production of a Cast Film from ARTON® R with a Thickness of 50 μm

Using a method based on Example 1, a solution was prepared from 1114 kg of ARTON® R (copolymer, R=H, methyl; X=H, methoxycarbonyl) and 2936 kg of dichloromethane, and was cast at 23° C. (solution temperature) in an atmosphere comprising about 2.5% by volume of dichloromethane vapor at a temperature of 32° C. onto a continuous steel belt of length 28 m and width about 1.20 m, circulating at 2.0 m/min. The casting gap width was about 250 μm. The air temperature for the drying in the belt duct was increased toward the take-off point in stages to 114° C., and then the film was peeled away. The film was then heated continuously over a length of 190 m to a maximum temperature of 95° C., and then, after cooling, cut to a width of 1010 mm, and wound up. Once stationary-state operating conditions had been achieved, the resultant film had a thickness of 49±1 μm, residual solvent content of 0.8%, and optical retardation of 1-2 nm. The haze measured was below 0.2%.

### EXAMPLE 4

Production of a Cast Film from ARTON® G

A solution of ARTON® G (34.5% by weight) in toluene was cast with the aid of a doctor blade at a layer thickness of 400 μm onto a glass plate and dried at 120° C. After a drying period of 35 min., the film could be released completely from the plate, but continued to exhibit a marked tendency to roll, which reduced greatly after 60 min.

### EXAMPLE 5

Production of a Cast Film from ARTON® G

The procedure was as described in Example 4, but the casting solution was treated with 0.01% by weight of release agent (polyethylene glycol ester), and a metal plate was used as casting substrate. Good release of the film from the plate was possible after as little as 20 min. of drying at 120° C.

1. A process for producing an optical film from a polyolefin of the formula 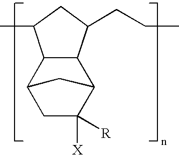
in which at every occurrence of the substituents R and X they are either both hydrogen or R is methyl and X is a polar group, and n is a number from 10 to 1000, by casting a solution of the polyolefin in an organic solvent onto a substrate and evaporating the solvent, characterized in that it encompasses the steps of
(i) dissolving the polyolefin in an organic solvent or solvent mixture,
(ii) casting the solution onto a smooth substrate in an atmosphere comprising at least 1% by volume of solvent vapor at a temperature below the boiling point of the solvent, with substantially laminar gas flow,
(iii) evaporating the solvent to obtain a self-supporting film, and
(iv) peeling the film away from the substrate and drying at a temperature rising to. 70-140° C., without any resultant orientation of the film.

2. The process as claimed in claim 1, characterized in that the organic solvent has been selected from the group consisting of dichloromethane, toluene, and cyclohexane, and also mixtures of these solvents.

3. The process as claimed in claim 2, characterized in that the organic solvent is dichloromethane, and the casting procedure takes place at a temperature not above 35° C.

4. The process as claimed in any of claims 1 to 3, characterized in that at least some of the substituents X are C₁₋₄-alkoxycarbonyl groups.

5. The process as claimed in claim 4, characterized in that at least some of the substituents X are methoxycarbonyl groups.

6. The process as claimed in any of claims 1 to 5, characterized in that the concentration of the polyolefin in the casting solution is from 20 to 35% by weight.

7. The process as claimed in any of claims 1 to 6, characterized in that the thickness of the film produced is from 30 to 200 μm.
